(19) United States
(12) Patent Application Publication
(10) Pub. No.: US 2010/0156218 A1
(43) Pub. Date: Jun. 24, 2010

(54) Spindle motor

(75) Inventors: Chang Jo Yu, Gyunggi-do (KR); Ho Kyung Jang, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/379,541

(22) Filed: Feb. 24, 2009

(30) Foreign Application Priority Data
Dec. 19, 2008 (KR) 10-2008-0130336

(51) Int. Cl. H02K 5/167; F16C 32/06

(52) U.S. Cl. 310/90; 384/112

(57) ABSTRACT

Disclosed herein is a spindle motor which prevents a sleeve from being deformed because of residual stress during the welding of a stopper for preventing the removal of a rotating shaft to which a thrust plate is coupled. The spindle motor includes a rotating shaft having a thrust plate which is fitted over the upper portion of the rotating shaft to be perpendicular to the rotating shaft. A sleeve accommodates the rotating shaft to rotatably support the rotating shaft. A stopper is coupled to the sleeve to support the upper surface of the thrust plate, thus preventing the removal of the rotating shaft. A stress-blocking groove is formed in the sleeve in such a way as to be adjacent to the stopper, and prevents the sleeve from being deformed by residual stress generated when the stopper is coupled to the sleeve.

### CROSS REFERENCE TO RELATED APPLICATION(S)

This application claims the benefit of Korean Patent Application No. 10-2008-0130336, filed on Dec. 19, 2008, entitled “spindle motor”, which is hereby incorporated by reference in its entirety into this application.

### BACKGROUND OF THE INVENTION

1. Field of the Invention

The present invention relates generally to a spindle motor and, more particularly, to a spindle motor which prevents a sleeve from being deformed because of residual stress during the welding of a stopper for preventing the removal of a rotating shaft to which a thrust plate is coupled.

2. Description of the Related Art

Generally, a spindle motor maintains the rotation characteristics of high precision, because a bearing housing a rotating shaft therein rotatably supports the rotating shaft. Because of these characteristics, the spindle motor has been widely used as the drive means of a hard-disk drive, an optical disk drive, and other recording media requiring high-speed rotation.

In such a spindle motor, a predetermined fluid is injected between a rotating shaft and a sleeve for the axial support of the rotating shaft so as to easily rotate the rotating shaft, and a hydrodynamic bearing is generally used to generate a dynamic pressure when the rotating shaft rotates.

The hydrodynamic bearing may have a dynamic pressure-generating groove so as to generate a dynamic pressure by the fluid during the rotation of the rotating shaft. Such a dynamic pressure-generating groove may be formed in the inner circumferential part of the sleeve which rotatably supports the rotating shaft or in a thrust plate which is installed to be perpendicular to the axial direction of the rotating shaft.

In the spindle motor constructed as described above, a stopper for preventing the removal of the rotating shaft is generally secured to an end of the sleeve through welding in such a way as to face the upper surface of the thrust plate. However, in the concrete, the inner circumferential part of the sleeve facing the rotating shaft may be deformed because of the residual stress applied to the sleeve while welding to securing the stopper to the sleeve. Therefore, it is difficult to realize stable dynamic pressure characteristics between the sleeve and the rotating shaft.

### SUMMARY OF THE INVENTION

The present invention has been made in an effort to provide a spindle motor which prevents residual stress from being transmitted to the inner circumferential part of a sleeve during the welding of a stopper for preventing the removal of a rotating shaft to which a thrust plate is coupled, thus having stable dynamic pressure characteristics.

In a spindle motor according to an embodiment of the present invention, a rotating shaft includes a thrust plate which is fitted over the upper portion of the rotating shaft to be perpendicular to the rotating shaft. A sleeve accommodates the rotating shaft to rotatably support the rotating shaft. A stopper is coupled to the sleeve to support the upper surface of the thrust plate, thus preventing the removal of the rotating shaft. A stress-blocking groove is formed in the sleeve in such a way as to be adjacent to the stopper, and prevents the sleeve from being deformed by residual stress generated when the stopper is coupled to the sleeve.

According to the present invention, the sleeve has the shape of a hollow cylinder to accommodate the rotating shaft therein. The sleeve includes an inner circumferential part which accommodates the rotating shaft and forms a radial dynamic bearing, a bearing surface which faces the lower surface of the thrust plate and forms a thrust dynamic bearing, and an annular mounting part which protrudes from the bearing surface so that the stopper is mounted to the mounting part.

The stress-blocking groove may be formed along the outer circumferential surface of the mounting part in a ring shape.

The stress-blocking groove may be formed along the upper surface of the mounting part in a ring shape.

Further, a fluid is injected between the rotating shaft and the inner circumferential part or between the thrust plate and the bearing surface to form a hydrodynamic bearing.

Furthermore, the stopper has a shape of a disk with a central hole. The edge of the central hole is tapered towards the thrust plate to provide a taper seal which stores the fluid between the stopper and the upper surface of the thrust plate.

The stopper is joined with the sleeve through laser welding, press fitting, hot-press fitting, or hot-press sliding coupling.

Further, the stopper is joined and secured to the sleeve through laser welding.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic sectional view illustrating a spindle motor according to the first embodiment of the present invention;

FIG. 2 is a schematic partially enlarged sectional view illustrating a sleeve and a stopper of FIG. 1;

FIG. 3 is a schematic sectional view illustrating a spindle motor according to the second embodiment of the present invention; and

FIG. 4 is a schematic partially enlarged sectional view illustrating a sleeve and a stopper of FIG. 3.

### DESCRIPTION OF THE PREFERRED EMBODIMENTS

Hereinafter, spindle motors according to the preferred embodiments of the present invention will be described in detail with reference to the accompanying drawings.

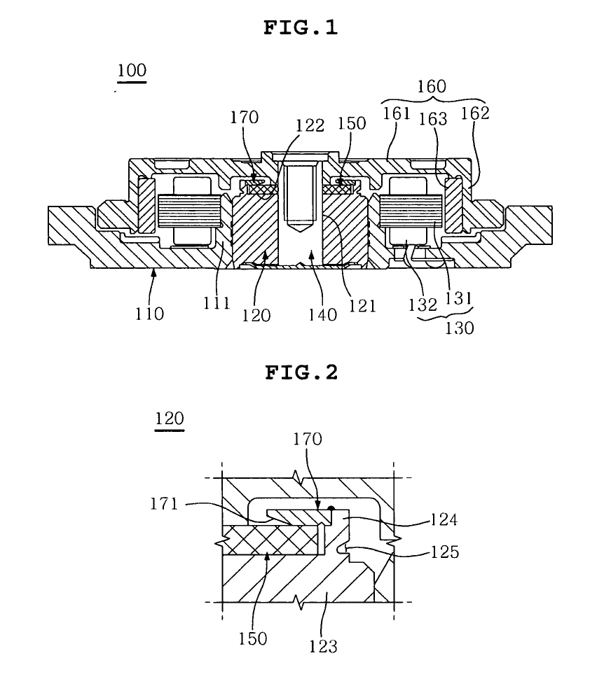

As shown in FIGS. 1 and 2, a spindle motor 100 according to the first embodiment of the present invention includes a plate 110, a sleeve 120, an armature 130, a rotating shaft 140, a thrust plate 150, a hub 160 and a stopper 170.

The plate 110 functions to support the entire spindle motor 100 and is mounted to a device such as a hard-disk drive in which the spindle motor 100 is to be installed. Here, the plate 110 is manufactured using a lightweight material such as an aluminum plate or an aluminum alloy plate. The plate 110, however, may alternatively be manufactured using a steel plate.

Further, a sleeve coupling part 111 protrudes from the plate 110 so that the sleeve 120 is coupled to the sleeve coupling part 111. A sleeve insert hole is formed in the central portion of the sleeve coupling part 111 and has the same diameter as the outer diameter of the sleeve 120 to receive the sleeve 120. That is, the sleeve 120 is inserted into and secured to the sleeve insert hole. In order to secure the sleeve 120 to the sleeve coupling part 111, an adhesion process using an adhesive may be performed. However, in place of performing the adhesion process, the sleeve 120 may be press-fitted into the sleeve insert hole under a predetermined pressure to be secured thereto.

The sleeve 120 functions to rotatably support the rotating shaft 140, and has the shape of a hollow cylinder. The sleeve 120 includes an inner circumferential part 121 which faces the rotating shaft 140, and a bearing surface 122 which faces the thrust plate 150. A hydrodynamic bearing is formed on each of the inner circumferential part 121 and the bearing surface 122. The construction of the sleeve according to various embodiments of the present invention will be described below in detail with reference to FIGS. 2 to 4.

The armature 130 forms an electric field by external power applied thereto, thus rotating the hub 160 on which an optical disk is mounted. The armature 130 includes a core 131 which is formed by laminating a plurality of metal sheets and a coil 132 which is wound several times on the core 131.

The core 131 is secured to the outer circumferential surface of the sleeve coupling part 111 of the plate 110, and the coil 132 is wound on the core 131. Here, the coil 132 forms an electric field using a current applied from the exterior, thus rotating the hub 160 by electromagnetic force generated between the coil 132 and a magnet 163 of the hub 160.

The rotating shaft 140 axially supports the hub 160, and is inserted into the inner circumferential part 121 of the sleeve 120 in such a way as to be rotatably supported by the sleeve 120. Meanwhile, the upper portion of the rotating shaft 140 may have a diameter smaller than that of a portion of the rotating shaft 140 inserted into the sleeve 120 so that the thrust plate 150 is fitted over the upper portion of the rotating shaft 140. In this case, in order to secure the thrust plate 150 to the upper portion of the rotating shaft 140, an additional laser welding operation may be implemented. However, in place of conducting the laser welding operation, a predetermined pressure may be applied to the thrust plate 150 so that the thrust plate 150 is coupled to the rotating shaft 140 through press-fitting.

The thrust plate 150 is secured to the rotating shaft 140, and a thrust hydrodynamic bearing is formed between the thrust plate 150 and the bearing surface 122 of the sleeve 120. A thrust dynamic pressure-generating groove (not shown) is formed in a portion of the thrust plate 150 which faces the sleeve 120. The thrust dynamic pressure-generating groove generates a fluid dynamic pressure using a fluid which is stored between the sleeve 120 and the thrust plate 150 during the rotation of the rotating shaft 140, thus forming the thrust hydrodynamic bearing between the bearing surface 122 of the sleeve 120 and the thrust plate 150. According to the embodiment, the thrust dynamic pressure-generating groove is formed in the thrust plate 150. However, the thrust dynamic pressure-generating groove may alternatively be formed in the bearing surface 122 of the sleeve 120.

The optical disk (not shown), such as a hard disk, is mounted on the hub 160, so that the hub 160 rotates the optical disk. The hub 160 includes a disk part 161 in which the rotating shaft 140 is installed, and an annular edge part 162 which extends from an end of the disk part 161.

The rotating shaft 140 is inserted into the central portion of the disk part 161. The edge part 162 extends in the axial direction of the rotating shaft 140 in such a way that the inner circumferential surface of the edge part 162 faces the armature 130. The magnet 163 forming a magnetic field is secured to the inner circumferential surface of the edge part 162, thus generating an electromagnetic force in cooperation with the electric field formed in the coil 132.

The stopper 170 supports the thrust plate 150, thus preventing the removal of the hub 160 and the rotating shaft 140. In order to support the upper portion of the thrust plate 150, the stopper 170 is joined to a mounting part 124 of the sleeve 120 through laser welding, press fitting, hot-press fitting or hot-press sliding coupling. Here, the stopper 170 has the shape of an annular disk. In order to form a taper seal between the thrust plate 150 and the stopper 170, the edge of the central hole of the stopper 170 may be tapered towards the thrust plate 150.

That is, as shown in FIG. 2, the edge of the stopper 170 is formed to have a surface 171 which is inclined towards the thrust plate 150. The taper seal is formed between the inclined surface 171 of the stopper 170 and the upper surface of the thrust plate 150 to store a fluid therein. When the fluid stored between the rotating shaft 140 and the sleeve 120 evaporates, so that the fluid is insufficient, the fluid stored in the taper seal is used.

As shown in FIG. 2, the sleeve 120 according to the first embodiment of the present invention includes a body part 123 and the mounting part 124. The body part 123 houses and supports the rotating shaft 140. The mounting part 124 protrudes in the axial direction of the rotating shaft 140, with the stopper 170 mounted to the mounting part 124 so as to prevent the thrust plate 150 from being removed from the rotating shaft 140.

The body part 123 has the shape of a hollow cylinder, and the inner circumferential part 121 is formed in the central portion of the body part 123 so that the rotating shaft 140 is inserted into the inner circumferential part 121. A radial dynamic pressure-generating groove (not shown) is formed in the inner circumferential part 121 to form a radial hydrodynamic bearing between the inner circumferential part 121 and the rotating shaft 140, and a fluid is stored between the inner circumferential part 121 and the rotating shaft 140. The radial dynamic pressure-generating groove generates a fluid dynamic pressure using the fluid stored between the sleeve 120 and the rotating shaft 140 during the rotation of the rotating shaft 140, thus forming the radial hydrodynamic bearing between the rotating shaft 140 and the sleeve 120. According to this embodiment, the radial dynamic pressure-generating groove is formed in the inner circumferential part 121 of the sleeve 120. However, the radial dynamic pressure-generating groove may be formed in the outer circumferential surface of the rotating shaft 140.

The mounting part 124 protrudes along the edge of the body part 123 by a predetermined height, with the stopper 170 installed on the upper portion of the mounting part 124. Here, in order to install the stopper 170 on the mounting part 124, the stopper 170 and the mounting part 124 may be joined together through a welding process, for example a laser welding process.

Meanwhile, in order to prevent residual stress from being transmitted to the body part 123, in the concrete, the bearing surface 122 of the body part 123 or the inner circumferential part 121 in which the dynamic bearing is formed, during laser welding, a stress-blocking groove 125 is provided in the mounting part 124.

As shown in FIG. 2, the stress-blocking groove 125 according to the first embodiment of the present invention may be provided along the outer circumferential surface of the mounting part 124 so as to prevent the residual stress from being transmitted to the body part 123. That is, the stress-blocking groove 125 of this embodiment may be formed along the outer circumferential surface of the mounting part 124 in a ring shape in such a way that the stress-blocking groove 125 forms a border between the mounting part 124 and the body part 123. According to this embodiment, the stress-blocking groove 125 may be formed to have the cross-section of a right triangle. However, as long as the stress-blocking groove 125 blocks the residual stress, any shape is possible.

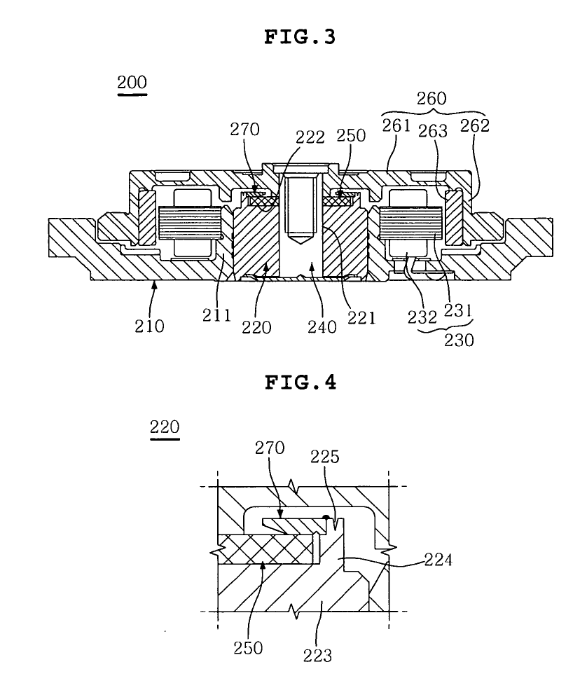

As shown in FIGS. 3 and 4, a spindle motor 200 according to the second embodiment of the present invention includes a plate 210, a sleeve 220, an armature 230, a rotating shaft 240, a thrust plate 250, a hub 260 and a stopper 270. The general construction of the spindle motor 200 according to the second embodiment is almost identical to that of the spindle motor 100 according to the first embodiment, except for a position in which the stress-blocking groove is formed.

As shown in FIG. 4, the sleeve 220 according to the second embodiment of the present invention includes a body part 223 and a mounting part 224. The body part 223 accommodates and supports the rotating shaft 240. The mounting part 224 protrudes in the axial direction of the rotating shaft 240, with the stopper 270 mounted to the mounting part 224 so as to prevent the removal of the rotating shaft 240 to which the thrust plate 250 is coupled.

The body part 223 has the shape of a hollow cylinder, and an inner circumferential part 221 is provided in the central portion of the body part 223 so that the rotating shaft 240 is inserted into the inner circumferential part 221. A radial dynamic pressure-generating groove (not shown) is formed in the inner circumferential part 221 to form a radial hydrodynamic bearing between the inner circumferential part 221 and the rotating shaft 240, with a fluid stored between the inner circumferential part 221 and the rotating shaft 240. The radial dynamic pressure-generating groove generates a fluid dynamic pressure using the fluid stored between the sleeve 220 and the rotating shaft 240 during the rotation of the rotating shaft 240, thus forming the radial hydrodynamic bearing between the rotating shaft 240 and the sleeve 220. According to this embodiment, the radial dynamic pressure-generating groove is formed in the inner circumferential part 221 of the sleeve 220. However, the radial dynamic pressure-generating groove may be formed in the outer circumferential surface of the rotating shaft 240.

The mounting part 224 protrudes along the edge of the body part 223 by a predetermined height, with the stopper 270 mounted to the upper portion of the mounting part 224. Here, in order to mount the stopper 270 to the mounting part 224, the stopper 270 and the mounting part 224 may be joined to each other through a welding process, for example, a laser welding process.

Meanwhile, in order to prevent residual stress from being transmitted to the body part 223, in the concrete, the bearing surface 222 of the body part 223 or the inner circumferential part 221 in which the dynamic bearing is formed, during laser welding, a stress-blocking groove 225 is provided in the mounting part 224.

As shown in FIG. 2, the stress-blocking groove 225 according to the second embodiment of the present invention may be provided in the upper surface of the mounting part 224 of the sleeve 220 so as to prevent the residual stress from being transmitted to the body part 223. That is, the stress-blocking groove 225 of this embodiment may be formed along the upper surface of the mounting part 224 in a ring shape. According to this embodiment, the stress-blocking groove 225 may be formed to have the cross-section of a right triangle. However, as long as the stress-blocking groove 225 blocks the residual stress, any shape is possible.

As described above, the present invention provides a spindle motor, in which a stress-blocking groove formed in a sleeve prevents residual stress, generated during the welding of a stopper which supports a thrust plate mounted to a rotating shaft to prevent the removal of the rotating shaft, from being transmitted to the bearing surface or inner circumferential part of the sleeve, thus preventing the deformation of the bearing surface or inner circumferential part of the sleeve in which a dynamic bearing is formed, therefore having stable dynamic pressure characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spindle motor, comprising:
a rotating shaft having a thrust plate which is fitted over an upper portion of the rotating shaft to be perpendicular to the rotating shaft;
a sleeve accommodating the rotating shaft to rotatably support the rotating shaft;
a stopper coupled to the sleeve to support an upper surface of the thrust plate, thus preventing a removal of the rotating shaft; and
a stress-blocking groove formed in the sleeve in such a way as to be adjacent to the stopper, and preventing the sleeve from being deformed by residual stress generated when the stopper is coupled to the sleeve.

2. The spindle motor as set forth in claim 1, wherein the sleeve has a shape of a hollow cylinder to accommodate the rotating shaft therein, and comprises:
an inner circumferential part accommodating the rotating shaft and forming a radial dynamic bearing;
a bearing surface facing a lower surface of the thrust plate and forming a thrust dynamic bearing; and
an annular mounting part protruding from the bearing surface so that the stopper is mounted to the mounting part.

3. The spindle motor as set forth in claim 2, wherein the stress-blocking groove is formed along an outer circumferential surface of the mounting part in a ring shape.

4. The spindle motor as set forth in claim 2, wherein the stress-blocking groove is formed along an upper surface of the mounting part in a ring shape.

5. The spindle motor as set forth in claim 3, wherein a fluid is injected between the rotating shaft and the inner circumferential part or between the thrust plate and the bearing surface to form a hydrodynamic bearing.

6. The spindle motor as set forth in claim 5, wherein the stopper has a shape of a disk with a central hole, an edge of the central hole being tapered towards the thrust plate to provide a taper seal which stores the fluid between the stopper and the upper surface of the thrust plate.

7. The spindle motor as set forth in claim 4, wherein a fluid is injected between the rotating shaft and the inner circumferential part or between the thrust plate and the bearing surface to form a hydrodynamic bearing.

8. The spindle motor as set forth in claim 7, wherein the stopper has a shape of a disk with a central hole, an edge of the central hole being tapered towards the thrust plate to provide a taper seal which stores the fluid between the stopper and the upper surface of the thrust plate.

9. The spindle motor as set forth in claim 1, wherein the stopper is joined with the sleeve through laser welding, press fitting, hot-press fitting, or hot-press sliding coupling.

10. The spindle motor as set forth in claim 1, wherein the stopper is joined and secured to the sleeve through laser welding.
